(19) United States
(12) Patent Application Publication
(10) Pub. No.: US 2015/0315779 A1
(43) Pub. Date: Nov. 5, 2015

(54) Construction Panels

(71) Applicant: Dow Corning Corporaton, Midland, MI (US)

(72) Inventors: Victor Baily, Braine-l'Alleud (BE); Lawrence Carbary, Midland, MI (US); Gluseppina Conti, Houdeng-Goegnies (BE); Tommy Detemmerman, Wezembeek-Oppern (BE); Davide Dei Santi, Boussu (BE); Thierry Dessilly, Dour (BE); Frederic Gubbels, Houtain-le-Val (BE); Valerie Hayez, Hoeilaart (BE); Mikkel Kragh, La Hulpe (BE)

(21) Appl. No.: 14/649,949

(22) PCT Filed: Dec. 6, 2013
(86) PCT No.: PCT/US2013/073605

§ 371 Date: Jun. 5, 2015

Related U.S. Application Data
(60) Provisional application No. 61/734,102, filed on Dec. 6, 2012.

(30) Foreign Application Priority Data
Dec. 6, 2012 (GB) 1221962.2

(51) Int. Cl. E04B 1/80; B32B 5/18; E06B 3/67; B32B 15/04; B32B 25/04; B32B 3/08; B32B 3/04; B32B 17/06

(52) U.S. Cl. CPC E04B 1/803; B32B 3/04; B32B 5/18; B32B 17/06; B32B 15/04; B32B 25/04; B32B 3/08; E06B 3/6715; B32B 2305/022; B32B 2307/536; B32B 2307/206; B32B 2419/00; B32B 2307/3065; B32B 2266/08; B32B 2266/02

(57) ABSTRACT

A composite non-vision insulation panel unit comprising an exterior sheet and an interior sheet which define a cavity there between, said cavity housing one or more insulation panels. The insulation panel(s) is/are spaced apart from said interior and exterior sheets respectively by means of a damping material having a shore A hardness value in the range of from 0 to 60 according to ASTM D 2240-05(2010), and the composite non-vision insulation panel unit is sealed with a sealant which maintains the cavity width between said interior and exterior sheet and encloses the cavity of the composite non-vision insulation panel units.

### CROSS-REFERENCE TO RELATED APPLICATIONS

This application claims priority to and all the advantages of U.S. Provisional Patent Application No. 61/734,102, filed on Dec. 6, 2012, and Great Britain Patent Application No. GB1221962.2, filed on Dec. 6, 2012, the contents of which are incorporated herein by reference.

### TECHNICAL FIELD

This disclosure relates to a composite non-vision insulation panel unit incorporating an insulation panel, in particular a vacuum insulating panel (VIP) for use in curtain wall facades and the like.

### BACKGROUND

A curtain wall facade is an outer wall of a building which is non-load bearing. Typically a curtain wall facade does not carry any dead load weight from the building other than its own dead load weight. The wall transfers horizontal wind loads that are incident upon it to the main building structure through connections at floors or columns of the building. A curtain wall façade is designed to resist air and water infiltration, sway induced by wind and seismic forces acting on the building and its own dead load weight forces. Being non-structural a curtain wall façade may be made from one or more lightweight materials e.g. glass in order to reduce construction costs. A composite non-vision insulation panel unit is intended to mean a panel unit which cannot be viewed through, whereas a vision panel unit is the likes of a window unit which can be viewed through.

Vacuum insulating panels (VIPs), often also referred to as ‘VIP panels’, are insulation panels derived from a highly efficient advanced thermal insulation technology, having at least 3-7 times more effective insulation ability than conventional plastic foams or fibrous insulation.

Insulation panels, such as VIP panels have been used for some time to enhance the performance of static goods such as refrigerators, and in refrigerated vehicles and more recently are increasingly being used in the insulation of buildings, especially with the aim of making buildings more thermally efficient. VIP panels are generally more compact (by being thinner) than existing insulation panels, ensuring savings in both space and energy. Insulation within ‘cavity’ walls is well known, but it is also desired to improve the insulation on the outside walls of buildings.

Insulation panels, especially VIP panels, are increasingly being used to form part of composite non vision insulation panel units, sometimes referred to as “spandrel panel units,” that are used in combination with vision panel units (e.g. window units) in the construction of curtain wall facades. Spandrel panel units are typically composite non vision insulation panel units in a multi-storey building, filling the space between the top of a vision panel unit (window unit) in one storey and the sill or bottom of a vision panel unit (window unit) in the storey above. These composite non-vision panel units or spandrel panel units are often composed of an exterior sheet for example a glass pane, a protected or unprotected insulation panel such as a VIP panel and an interior sheet that can be composed of glass, metal, plastic or wood or other architecturally acceptable material. Many possible combinations of interior sheets, exterior sheets and insulating panels have been proposed for use in spandrel panel units. The exterior sheet has an outward facing surface. The term “exterior” is used herein to mean external to the building i.e. it forms part of the exterior surface of the building (i.e. the visible face of the façade wall or in the case of a composite panel unit used in for example an interior dividing wall in a building outward is intended to mean the opposite to the “wall-meeting surface”, i.e. the visible face of the composite panel, and in the same way that most building walls have an inner facing surface and an outer or outward facing surface. Generally the “exterior” facing surface of a panel unit is that surface of the panel which is still visible following the application of the panel to a wall.

Like multiple glazed windows, it is important for composite non-vision insulation panel units to maintain their structure throughout their lifetime. VIP panels, by necessitating the need for a vacuum, are generally less robust than more traditional means of insulation, and require protection during installation and fixing as well as during their lifetime to withstand the handling involved and maintain the vacuum in the VIP panels. Thus, for building purposes insulation panels, requiring vacuum, e.g. VIP panels are:—
(i) Protected on all sides by discrete layers of protective materials such as sheets of glass fibre and/or extruded thermoplastic polymer foams,
(ii) Protected in an envelope, or composite of e.g. glass fibre and/or protective extruded thermoplastic polymer foam; or
(iii) Protected by a frame of protective extruded thermoplastic polymer foam around the periphery of a VIP panel.

However, the materials currently used to protect the existence of the vacuum in the VIP panels by vibration and/or energy damping or cushioning, are rigid in nature and as such may collapse or crumble under continuous pressure (e.g. polystyrene) applied by the exterior and interior sheets. The vibration and/or energy damping or cushioning protection material is not only intended to protect the VIP panels during transportation and installation, but also in the case of their use in curtain wall facade systems the composite non vision panel units are expected to sway induced by wind and seismic forces acting on the building and therefore uneven pressures may be applied on the units which can result in damage to the VIP panels given the physical nature of the protecting materials.

Alternatively or additionally composite non-vision insulation panel units containing VIP panels may be sealed around the perimeter with a spacer and sealant system which ensures that the unit is hermetically sealed and sufficiently stable to withstand thermal and physical e.g. windload stresses on the unit.

The spacer, usually consisting primarily of metal (e.g. aluminium), is located in the edge area of the exterior and interior sheets, and has the function of maintaining the exterior and interior sheets at a pre-determined distance apart. A wide variety of spacebars or spacers (hereinafter referred to as “spacers”) have been proposed for multiple glazed units. They are generally manufactured in stainless steel, aluminium and more recently using appropriate organic materials. The spacers made from organic materials are typically made from thermoplastic materials e.g. polyisobutylenes and butyl rubber based spacers. Some silicone foam based spacers have also proposed. The spacer profile of composite non-vision insulation panel units containing spacers defines maintains dimensions of the cavity or cavities between the interior and exterior sheets into which insulation panels, e.g. VIP panels are placed. However, cumulatively, the spacers used in the individual composite non-vision insulation panel units making up a curtain wall facade may make a significant contribution to the total thermal conductivity of the curtain wall façade, via what is often referred to as the “edge contribution” to the thermal conductivity of each panel. The edge contribution of the panel unit is dependent on the thermal conductivity of the spacer. If the spacer is highly thermally conductive because it is made from metal the edge contribution to the thermal conductivity of the whole panel is significant compared to the remainder of the panel. It is therefore preferred to minimize the thermal conductivity of each spacer utilized to reduce the overall thermal conductivity of the curtain wall façade.

Typically for composite non-vision insulation panel units organic spacers perform generally better than stainless steel spacers, which perform generally better than aluminium spacers because of their relative thermal conductivities. However, the physical design of the spacer can also contribute to the magnitude of the edge contribution because a large volume organic based spacer may have a greater thermal conductivity than e.g. a comparatively thin steel spacer having thin walls.

Whilst condensation may impair thermal performances of the insulation material and also may affect the adhesion properties of the sealant, its presence in composite non-vision insulation panel units is not as critical as in a vision panel unit as its presence does not affect the aesthetic perception of composite non-vision insulation panel units. However, when used, a spacer may also contain desiccant which keeps the cavity free of moisture. When desiccant is used the spacer is structurally hollow allowing a desiccant (e.g. molecular sieve) to be contained therein in order to keep the air or gas trapped in the cavities formed between the interior and exterior sheets and defined by the spacer dry. To enable the desiccant to absorb moisture, the spacer is provided with small apertures (e.g. longitudinal perforations) on the side facing the cavities. This arrangement prevents moisture from condensing on the inside individual units. This issue can occur due to the variable temperature differences of the exterior and interior sheets. For example, typically on a cold night the temperature of the exterior sheet exposed to the weather is several degrees centigrade colder than the temperature of the interior sheet which can cause unwanted condensation inside the panel unit.

Between the sides of the spacer that face the interior and exterior sheets respectively, a seal based on polyisobutylene and/or butyl rubber may be provided. This seal is generally known as the “primary seal”. The function of the primary seal is, during production of the composite non-vision insulation panel units, to be a kind of “assembly aid” while the interior and exterior sheets are being joined to the spacer, which has been pre-coated with primary sealant, in order to hold the assembly together during the next production stages, and later, during the service life of the composite non-vision insulation panel unit, to form a water-vapour barrier that prevents moisture from penetrating from the exterior inwards into any cavities in the unit, and, if the unit is filled with gas, to prevent loss of this gas outwards from said cavities.

As the outward-facing edge of the spacer is a few millimetres inside of the outside edges of the interior and exterior sheets, a “channel” is formed into which a secondary sealant, as it is generally known, is injected. The main purpose of the secondary seal is to elastically bond the edge of the interior and exterior sheets and the spacer and also to form a seal-which is to some extent an additional seal-against water and water vapour from the outside and gas from the internal cavities. As a rule, the secondary seal consists of room-temperature-curing, two-part sealants and/or adhesives based on polysulfide, polyurethane or silicone. One-part systems, for example based on silicone, or a hot-melt butyl adhesive applied while hot, are also available.

DE4339435 describes a thermal insulation panel having two plates spaced apart by 5-50 mm. and sealed at their edge joint by a gas or vacuum tight material. A VIP type panel made of finely dispersed powder or fibrous material inside possibly a fleece-like and microporous gas and water-tight cover (5) is inserted between the plates. An adhesive is used to adhere the VIP panel to the two plates. EP1180183 discloses a heat insulating panel for windows, doors and building faces houses having a top and bottom cover plate between which is at least one VIP insulating unit. The insulating unit is not joined to the inner surfaces of the cover plates, the cover plates are divided by a spacer and a sealant is used to seal periphery of the panel. EP2366840 describes a thermal insulation system having two glass panes between which a vacuum-insulation-panel is situated. The glass panes are spaced apart by a spacer and a sealant is used to seal periphery of the panel. In this case the cavities between the VIP panel and each glass panel are filled with glass fibres, carbon fibres or mineral wool.

### BRIEF SUMMARY OF THE INVENTION

It is an object of the present invention to provide an improved composite non-vision insulation panel unit containing a VIP panel for use in the insulation of curtain wall facades and the like.

This disclosure provides a composite non-vision insulation panel unit comprising an exterior sheet and an interior sheet which define a cavity there between, said cavity housing one or more insulation panels; wherein, said insulation panel(s) is/are spaced apart from said interior and exterior sheets respectively by means of a damping material having a shore A hardness value in the range of from 0 to 60 according to ASTM D 2240-05(2010), and wherein the composite non-vision insulation panel unit is sealed with a sealant which maintains the cavity width between said interior and exterior sheet and encloses the cavity of the composite non-vision insulation panel units.

### BRIEF DESCRIPTION OF THE DRAWINGS

Embodiments of the present invention will now be described by way of example only and with reference to the accompanying drawings in which:

FIG. 1 is a cross-sectional view of a composite non-vision insulation panel unit as hereinbefore described in which the insulation panel is framed with damping material;

FIG. 2 is a cross-sectional view of an alternative composite non-vision insulation panel unit as hereinbefore described in which the insulation panel is wrapped/enveloped/sheathed in damping material;

FIG. 3 is a plan view of a composite non-vision insulation panel unit as depicted in FIG. 1 with the exterior sheet 1 removed having a plurality of setting blocks inserted around the insulation panel;

FIG. 4 is a plan view of a composite non-vision insulation panel unit as depicted in FIG. 3 with the setting blocks removed; and

FIG. 5 is a plan view of a composite non-vision insulation panel unit as depicted in FIG. 4 with the setting blocks replaced by sealant or a plan view of a composite non-vision insulation panel produced without the use of setting blocks.

### DETAILED DESCRIPTION OF THE INVENTION

Hence, there is provided a, preferably, spacerless design for composite non-vision insulation panel units as hereinbefore described. One immediate benefit of the removal of a thermally conductive spacer is the potential substitution of this surface area (previously taken up by the spacer) by an equivalent surface area of insulation material, which will reduce the edge contribution of the composite non-vision insulation panel unit and consequently, in use, the thermal conductivity of the curtain wall façade in which the panel unit is situated. Hence this disclosure describes a means of reducing energy consumption of a building in comparison with a curtain wall facade assembled with composite non-vision insulation panel units having spacers. The curable sealant utilised serves to adhere the exterior and interior sheets together as well as negating the need of the spacer once cured. Composite non-vision insulation panel units as hereinbefore described are especially useful for non-vision panels, where a very low thermally conductive material such as for example an aerogel or a VIP panel is used in the insulation panel(s). However, the gain will be less significant when standard insulation materials such as plastic foams or fibrous panels are used in composite non-vision insulation panel units included in the curtain wall facade as it is known to the people skilled in the art that edge contribution of a composite non-vision insulation panel unit is increasing when the thermal resistivity of the insulator increases. As the thermal conductivity of secondary sealants is lower than the thermal conductivity of metals the surface area of the spacer can be replaced by an equivalent surface area of the secondary sealant, which will result in a reduction in thermal conductivity of each unit. As a spacer does not contribute significantly to the tensile or shear resistance of the composite non-vision insulation panel unit its replacement by an additional amount of secondary sealant will improve tensile and shear resistance of the unit.

Materials to be used as insulators between the interior sheet and exterior sheet can be but are not limited to vacuum insulation panels (VIPs) made out of fumed or precipitated silica, glass fibres, expanded or extruded polystyrene, polyurethane, polyisocyanurate foams, alumina, treated silica or alumina etc. Insulation panels which do not require vacuum may be utilised herein and typically comprise aerogels, xerogels, plastic foams, such as polyurethane, expanded polystyrene (EPS), extruded polystyrene (XPS), mineral wool, such as glass fibres or rock wool, nano foams, or any other insulation materials or a combination of one or more of these.

The sealant as hereinbefore described may comprise a silicone sealant, a polysulphide sealant, a polyurethane sealant, a polyacrylate, a butyl sealant, hybrid sealants such as silyl terminated or modified organic sealants or non-telechelic hybrid sealants and or structural tapes. Of these silicone sealants are preferred as they have the ability to resist high temperatures far better than organic sealants and suffer far less from problems such as softening and water creep. The non silicone sealants may fail after 5 to 10 years whereas silicone sealants are far longer lasting. Furthermore, silicone sealants have high moisture permeability after cure and therefore can be used to help the diffusion of gases and humidity in and out of the composite non-vision insulation panel units in a ventilated or closed unit. A composite non-vision insulation panel unit may be described as a more breathable unit than when using lower gas permeable sealants. Nevertheless, in some designs a less breathable unit may be advantageous. In order to reduce the gas permeability of composite non-vision insulation panel units lower gas permeable materials such as a polyurethane sealant or a polysulphide sealant, a low gas permeable silicone sealant or a silyl acrylate can be used to reduce gas permeability of the pane. The sealant can be formulated to exhibit a very low thermal conductivity such in WO2010076893A1. The sealant can also be made of structural foams such as described in U.S. Pat. No. 2,655,485 in order to reduce thermal conductivity of the system around the edges. A high green strength sealant (WO2012119940A1) can be used to facilitate the mounting of the unit. A structural tape can be used in place of a sealant to hold the interior and exterior sheets together. Such silicone sealants have a lower thermal conductivity than both aluminium and steel and a thermal conductivity value approximately the same as that of organic based spacers. However, typically the silicone based material will have comparatively stronger mechanical properties than organic spacers. This is particularly important in high rise buildings because the units in a façade at a much higher altitude than those at ground level will be subjected to winds at significantly higher wind speeds resulting in the need of greater amounts of sealant to enhance strength. Silicone compositions are significantly better at providing such properties than organic sealants indeed in this case the additional strength may be provided by removal of the spacer and filling the space in which the spacer was positioned with further sealant.

The use of a spacer having a low thermal conductivity e.g. <0.3 W/mK such as previously mentioned can help to reduce the thermal conductivity of the in composite non-vision insulation panel unit but will still have to be used in combination with a quantity of secondary sealant in order to adhere the exterior and interior sheets together. For units where the thermal conductivity of a low thermal conductivity spacer is higher than the thermal conductivity of the insulation material the use of an increased surface area of insulating material (e.g. VIP panel) provided by the removal of the spacer is beneficial for the thermal resistivity of the panel. Alternatively, the space in the cavity of the unit left by the removal of the spacer may be utilised to apply an additional amount of sealant rather than increase the presence of insulation material which will provide a beneficial improvement in the mechanical properties of the unit without compromising the thermal conductivity since silicone sealants and low conductive spacers have thermal conductivities in the same order of magnitude, i.e. approximately 0.3 W/mK. For example enhanced mechanical properties will improve unit resistance to tensile stresses such as wind load during the lifetime of the unit.

A composite non-vision insulation panel unit as hereinbefore described can be produced in a variety of forms, for example a composite non-vision insulation panel unit may be hermetically closed or non-hermetically closed. Hermetically closed composite non-vision insulation panel units are produced by having a continuous seal around the whole of the periphery of the unit to constitute a barrier to liquids and solids. Such units are henceforth referred to as “Closed composite non-vision insulation panel units”. In closed composite non-vision insulation panel units one or more valves may be utilized in the sealant to equilibrate gas pressure in the unit. Alternatively non-hermetically closed units (i.e. open units) may be provided in which the sealant is not continuously around the whole periphery of the unit. In such units intermittent gaps may be provided between sealed sections. These open composite non-vision insulation panel units can be assembled in various ways so to equilibrate pressures between the internal cavity and the exterior.

The closed composite non-vision insulation panel units are initially good barriers to moisture but may not constitute a permanent barrier to water vapour, which can condense inside a unit during the heating and cooling cycles of a composite non-vision insulation panel units (like a standard window). Hence it may be advantageous for desiccant to be used to retard the condensation in particularly the closed composite non-vision insulation panel units.

The open composite non-vision insulation panel units may be designed to allow equilibration of pressures, while maintaining liquids and solids outside the pane with the help of for instance a small capillary. This capillary can be connected to the exterior of the façade in order to leave the humidity outside of the building. However, systems where such a connection is absent can be assembled.

In one embodiment setting blocks which may be used as a temporary means of keeping the interior and exterior sheets apart by the pre-determined distance required and sealant may be inserted into the spaces between adjacent setting blocks and then allowed to cure and then the setting blocks may be removed subsequent to cure or once the sealant material is sufficiently cured. The gaps left by the removed setting blocks may then be filled with sealant in the case of closed composite non-vision insulation panel units or if open composite non-vision insulation panel units are required, at least one of the gaps between sealant is left unsealed or partially unsealed in order to provide the ability to equilibrate the open composite non-vision insulation panel units. In a further alternative one or more or even all the setting blocks may be designed to be adhered to the sealant and form part of the composite non-vision insulation panel units and thereby provide additional support for keeping the interior and exterior sheets apart during the lifetime of the unit. The setting blocks can be made of any material, but should preferably be made of a material on which the sealant cannot adhere to facilitate their removal (unless they are intended to form part of the composite non-vision insulation panel units themselves. The setting blocks may be positioned in any particular position but typically may be placed either on the edge or at the corners of the unit. The quantity of sealant required will depend on the application and should follow the best practices in terms of sealant dimensions.

Typically if removable the setting blocks may have a non-stick coating e.g. a Teflon® coating or may be blocks actually made from Teflon®. Teflon® is a Registered Trademark of E. I. du Pont de Nemours and Company or its affiliates. In one alternative the setting blocks are made from a material having a hardness of value greater than 10 in accordance with shore A scale (ASTM D2240-05(2010), alternatively a hardness equal or higher than 30 in accordance with shore A scale (ASTM D2240-05(2010) and in a further alternative above 60 in the shore A scale (ASTM D2240-05(2010).

Setting blocks can be of any shape having a hardness of value higher than 10 in the shore A scale, more preferably a hardness equal or higher than 30 in the shore A scale and even more preferably a hardness above 60 in the shore A scale (ASTM D2240-05(2010).

One benefit of this design is to facilitate the repair of damaged units. This is especially true in a system filled with evacuated insulating materials where no adhesion between the sealant and the inner of the panel is obtained. In this case the sealant can easily be cut through with a knife or the like (in a similar fashion to the way car windshields are replaced when damaged). The failing device can be easily replaced and re glued applying for instance a moisture curable sealant on the freshly cut seal.

The unit as hereinbefore described comprises one or more insulation panels or the like, e.g. VIP panels in between the interior sheet the exterior sheet. As a result the insulation panel e.g. VIP panel will be subjected to the external stresses that are applied on the exterior sheet when in position in the curtain wall façade as well as on the adhesive. These stresses can induce failure in the insulation panel, in particular in the case of VIP panels the vacuum may be lost because of damage caused by the stresses concerned. The present invention therefore additionally provides a means of isolating the insulation material e.g. one or more VIP panels from external stresses.

The insulation panel e.g. VIP panel or an assembly of insulation panels e.g. VIP panels is either retained in an envelope or sheath of damping material or is framed in said damping material. The damping material may be anything which is softer than the exterior sheet but in practice a “soft” material is preferred. In one alternative, the damping material dampens the movements of the exterior sheet, interior sheet and the peripheral sealant and exhibits a Shore A hardness of between 0 and 60 according to ASTM D 2240-05(2010), alternatively a Shore A hardness of between 0 and 50 according to ASTM D 2240-05(2010), alternatively Shore A hardness of between 0 and 40 according to ASTM D 2240-05(2010) or alternatively a Shore A hardness of between 0 and 30 according to ASTM D 2240-05(2010). A hard material will transfer external loads (e.g. wind load) applied onto the exterior sheet directly to the VIP without dampening. Without damping the VIP may easily be damaged and/or compressed and e.g. vacuum lost. This can potentially lead to an increase of thermal conductivity or by applying stress on the VIP film with increased risks of failure of the insulation panel. The damping material was chosen to have a shore A hardness of less than 60 as hereinbefore indicated is selected such that the damping material has a shore A hardness equal to or less than the peripheral sealant(s). If this is not the case the sealant deformation subsequent to the application of an external force onto the exterior sheet will be greater than the deformation of the dampening material, which should be avoided to ensure the damping material functions to dampen the external load and protect the VIP. The damping material may be, but is not necessarily, an insulation material itself. Whilst the sealant may adhere to the damping material, in one embodiment to further dampen the movements and the stresses the sealant as hereinbefore described, does not adhere to the damping material.

The damping material may be a closed cell foam which exhibits a Shore A hardness of between 0 and 60 according to ASTM D 2240-05(2010), alternatively a Shore A hardness of between 0 and 50 according to ASTM D 2240-05(2010) or alternatively Shore A hardness of between 0 and 40 according to ASTM D 2240-05(2010) or alternatively a Shore A hardness of between 0 and 30 according to ASTM D 2240-05(2010). Examples of suitable closed cell foams include silicone closed cell foams, fluoropolyether closed cell foams, polyolefin closed cell foams such as polyethylene (PE) closed cell foams or polypropylene (PP) closed cell foams or a mixture thereof. One advantage of using a polyolefin closed cell foam is that the sealant will not adhere to the damping material once cured, which will further protect the insulation board from external forces and will dissipate the stresses on the sealant away from the insulation board thereby helping maintain the integrity of the vacuum of the insulation board in the case where a VIP panel is used. Open cell foams are less desirable because they may generate bubbles in the sealant during the cure. Highly polar polymeric foams such as polyurethane foams are less desirable because they may promote adhesion with the sealant and hence eliminate the advantage here above mentioned.

In the case where the insulation panels, particularly VIP panels, are framed in damping material the frame around the VIP panels may be in the form of a PE closed cell foam tape dimensioned wider than the thickness of the VIP panel(s) such that it may be adhered to the VIP panel(s) in a U or C-shaped cross-sectional shape around the periphery of the panel(s). A flexible flat shape can also be used, which may be folded to form a U shape. In one embodiment the frame may not be continuous around the whole of the VIP panel(s) periphery, i.e. the frame may only be present at corners of the VIP panel(s). However, it will be appreciated that when the damping material is continuous around the periphery of the panel(s), the frame defines a first inner cavity between the exterior sheet and the VIP panel(s) and a second inner cavity between the interior sheet and the VIP panel(s), which may be advantageous from a thermal insulation perspective since this will eliminate the possibility of air convection taking place between the first and second inner cavities. The first inner cavity or the second inner cavity or both inner cavities may in such cases be filled with another material for example a low thermally conductive gas such as argon, xenon or krypton or a mixture thereof (which would replace air).

A flat shape polyethylene foam can be used to stick the folds of the VIP panel in place of the standard PSA tapes that are most conventionally used for such a purpose.

Alternatively the damping material may be preformed and subsequently adhesively or frictionally secured to the VIP panel(s). In a further alternative the damping material may be foamed or moulded about the periphery of the VIP panel(s). In another embodiment the insulating panel is sandwiched between two sheets of closed cell PE foam prior to the sealing of the unit. In a still further alternative the VIP panel(s) may be wrapped, enveloped or sheathed in a suitable pre-shaped article of the damping material.

An adhesive, such as a pressure sensitive adhesive may be utilised to adhere the damping material to the VIP panel(s) to facilitate assembly, especially if several VIP panels are used in between the exterior sheet and interior sheet. Such an adhesive can also be placed between the damping material and the exterior sheet, between the damping material and interior sheet or between the damping material and the exterior sheet, and between the damping material and interior sheet to facilitate the assembling process. The adhesive may be a standard butyl primary seal e.g. a polyisobutylenes which would provide the additional benefit of the provision of gas barrier properties to the unit.

The presence of the PE foam and the absence of metallic spacer may provide both damp vibrations and also improve sound insulation. This is because sound insulation depends on a lot of parameters such as the Young's modulus of a conductive medium. The provision of soft material such as the sealant and/or damping material as hereinbefore described instead of a rigid frame or spacer will help for the noise reduction of the unit.

In one embodiment herein the exterior and interior sheets respectively may be provided in a composite non-vision insulation panel unit with different thicknesses so that e.g. the exterior sheet may be thicker to reduce the visual impact of the loss of vacuum in the case where an evacuated insulating material (e.g. a VIP panel) is used. Such loss of vacuum may be due to natural ageing that is due to the diffusion of gases from the internal cavity into the evacuated VIP panel leading to a pane deflection. It can also be the result of a failure in the packaging of the evacuated (VIP) panel. Such a defect could temporarily lead to the deflection of sheets or even to the failure of one of the composite non-vision insulation panel units in a curtain wall façade. The assembly could therefore be constructed to have the interior sheet bend in the case of failure of the evacuated (VIP) panel in order to prevent the equivalent exterior sheet from breaking.

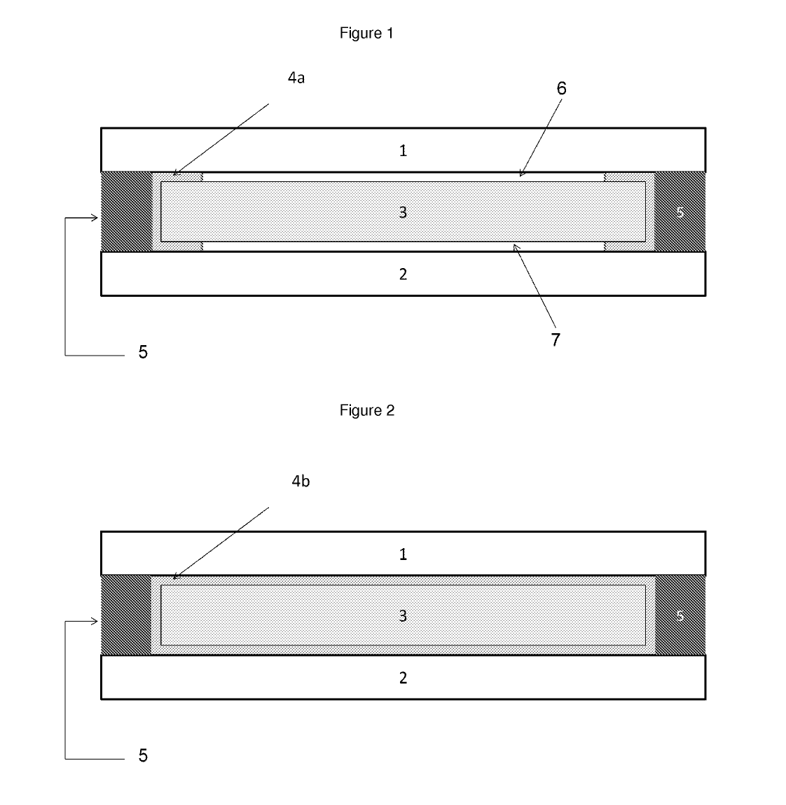

FIG. 1 illustrates a composite non-vision insulation panel unit as hereinbefore described comprising an exterior sheet 1, an interior sheet 2 which define a cavity there between, said cavity housing one or more insulation panels 3 which are separated from sheets 1 and 2 with a frame of a damping material 4a which surrounds the periphery of the insulation panels 3. Damping material 4a has a shore A hardness value in the range of from 0 to 60, alternatively 0 to 50 according to ASTM D 2240-05(2010) and is typically a polyethylene closed cell foam. The composite non-vision insulation panel unit is sealed with a sealant 5 which maintains the cavity width between said interior sheet 2 and exterior sheet 1 and encloses the cavity of the composite non-vision insulation panel units. Internal voids 6, 7 between the top of insulation material 3 and the internal face of exterior sheet 1 and between the bottom of insulation material 3 and the internal face of interior sheet 2 sheet 1 are defined by the dimensions including thickness of the frame being utilised and are optionally provided with low thermally conductive gas selected from argon, xenon, krypton and mixtures thereof.

FIG. 2 illustrates an alternative a composite non-vision insulation panel unit as hereinbefore described in which the frame of damping material 4a has been replaced by a wrapping, envelope or sheath of insulation material 4b, thereby avoiding the presence of voids 6 and 7. Damping material 4b is typically the same as damping material 4a and has a shore A hardness value in the range of from 0 to 60 alternatively 0 to 50 according to ASTM D 2240-05(2010) and is typically a polyethylene closed cell foam. In FIG. 2 a layer of primary sealant e.g. polyisobutylenes may be provided to adhere the damping material to the interior face of either the exterior sheet 1 or the interior sheet 2.

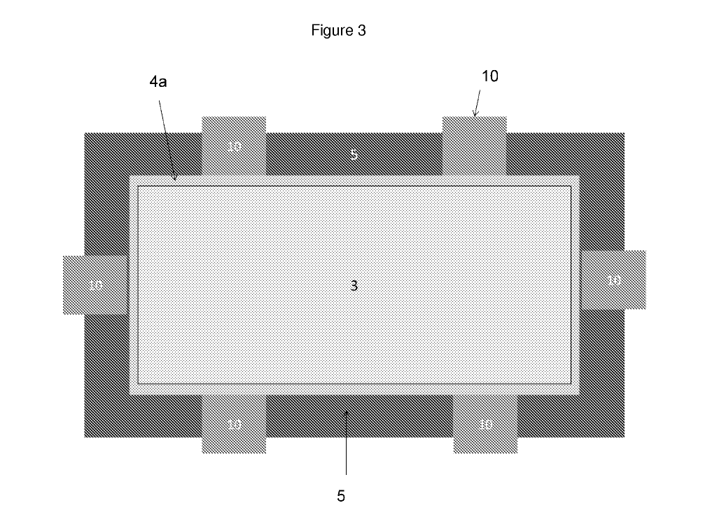

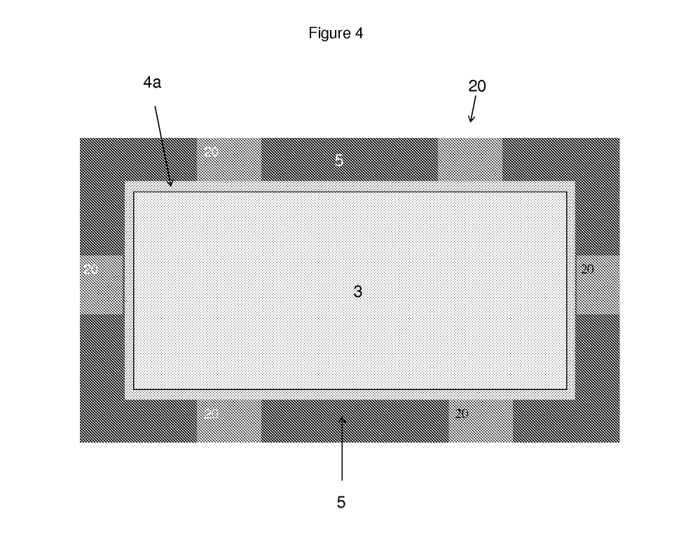

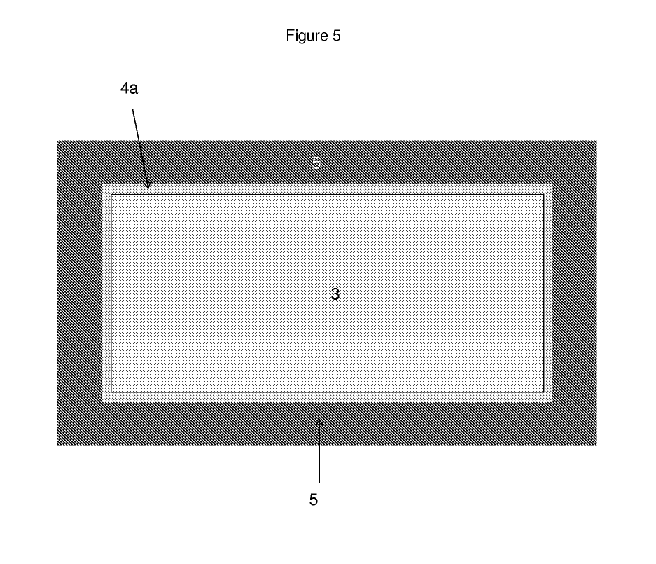

FIG. 3 illustrates is a plan view of a partially manufactured composite non-vision insulation panel unit as depicted in FIG. 1 with the exterior sheet 1 removed. In a method of manufacturing of a composite non-vision insulation panel unit insulation panel 3 is framed with a polyethylene closed cell foam via any suitable method. One suitable method is by applying a tape 4a of polyethylene closed cell foam around the periphery of insulation panel 3 and adhering the damping material 4a to the periphery of the insulation panel 3 in a C-shaped cross section. Subsequent to application of the damping material 4a the framed insulation panel 3 is placed centrally on interior sheet 2. This may be completed by auto centering of framed insulating panel 3, auto alignment of outer panels and auto spacing between both exterior and interior sheets. Exterior sheet 1 is then placed on top of the framed insulation panel. A series of removable setting blocks of an appropriate height are inserted in the channel defined by the end of damping material and the outer edges of exterior sheet 1 and interior sheet 2. The remainder of the channel is then filled with a silicone sealant. The silicone sealant is allowed to cure and then the setting blocks removed. The setting blocks are provided as temporary or permanent spacers prior to cure of the sealant. Once cured the sealant functions as the spacer by maintaining the distance of the interior sheet 2 and exterior sheet 4 and the setting blocks may be removed if desired. The setting blocks 10 may be retained as seen in FIG. 3 but are typically removed thereby leaving a series of discontinuities 20 as depicted in FIG. 4. Discontinuities 20 may be used to ventilate the insulation panel 3 (non-hermetically closed panels) or alternatively once removed discontinuity may be filled with sealant in order to provide a fully sealed composite non-vision insulation panel unit (hermetically closed panel) as depicted in FIG. 5. Other means of discontinuities can be designed to ensure ventilation of the unit.

1. A composite non-vision insulation panel unit comprising an exterior sheet and an interior sheet which define a cavity there between, said cavity housing one or more insulation panels; wherein, said insulation panel(s) is/are spaced apart from said interior and exterior sheets respectively by means of a damping material having a shore A hardness value in the range of from 0 to 60 according to ASTM D 2240-05(2010), and wherein the composite non-vision insulation panel unit is sealed with a sealant which maintains the cavity width between said interior and exterior sheet and encloses the cavity of the composite non-vision insulation panel unit.

2. A composite non-vision insulation panel unit in accordance with claim 1 wherein the exterior sheet and interior sheet are independently made of glass, metal, plastic, composite, ceramic, coated wood, solar thermal, solar photovoltaic, stone, concrete or a mixture of two or more thereof.

3. A composite non-vision insulation panel unit in accordance with claim 2 wherein the interior sheet is made of glass and/or metal and the exterior sheet is made of glass.

4. A composite non-vision insulation panel unit in accordance with claim 1 wherein said insulation panel(s) are framed continuously around the periphery of the panel(s), thereby defining a first inner cavity between the exterior sheet and the VIP panel(s) and a second inner cavity between the interior sheet and the VIP panel(s), which inner cavities may be filled with a low thermally conductive gas instead of air.

5. A composite non-vision insulation panel unit in accordance with claim 4 wherein the low thermally conductive gas is selected from argon, xenon, krypton and mixtures thereof.

6. A composite non-vision insulation panel unit in accordance with claim 1 wherein the insulation panel(s) is/are VIP Panel(s).

7. A composite non-vision insulation panel unit in accordance with claim 6 wherein each VIP panel is made from a highly-porous material, selected from hydrophobically treated or untreated fumed silica, hydrophobically treated or untreated precipitated silica, alumina or a mixture thereof, aerogel, perlite, plastic foam, plastic fibres, and mineral fibres.

8. A composite non-vision insulation panel unit in accordance with claim 1 where setting blocks are provided as temporary spacers can be used to facilitate the production.

9. A composite non-vision insulation panel unit in accordance with claim 1 where a primary butyl rubber is on the surface of the insulating panel or on the surface of the damping material to prevent moisture ingress.

10. A composite non-vision insulation panel unit in accordance with claim 1 wherein the one or more intermediate insulation panels are retained in an envelope or sheath of a damping material.

11. A composite non-vision insulation panel unit in accordance with claim 1 wherein said insulation panel(s) is/are spaced apart from said exterior sheet and said interior sheet respectively by framed structure of a tape of foam or a foam of U shaped cross-section of damping material.

12. A composite non-vision insulation panel unit in accordance with claim 10 wherein the damping material is a closed cell foam.

13. A composite non-vision insulation panel unit in accordance with claim 10 wherein the damping material is selected from silicone closed cell foams, fluoropolyether closed cell foams, polyolefin closed cell foams or a mixture thereof.

14. A composite non-vision insulation panel unit in accordance with claim 1 comprising a flame retardant.

15. A composite non-vision insulation panel unit in accordance with claim 1 comprising a pressure relief valve.

16. A composite non-vision insulation panel unit in accordance with claim 1 wherein the damping material is an insulation material.

17. A composite non-vision insulation panel unit in accordance with claim 1 wherein first and second protective plates are kept apart by a spacer.

18. A composite non-vision insulation panel unit in accordance with claim 1 wherein the exterior and interior sheets are of different thicknesses.

19. A method of preparing a composite non-vision insulation panel unit in accordance with claim 1 comprising the steps of pre-assembling the insulation panel(s) with the help of a damping material prior to its insertion in between the inner and outer sheets with the optional use of setting blocks and finally sealing of the pane with sealing processes.

20. A composite non-vision insulation panel unit comprising:
an exterior sheet and an interior sheet which define a cavity there between,
said cavity housing one or more insulation panels; and
a sealant that encloses the cavity of the composite non-vision insulation panel units,
wherein said insulation panel(s) is/are spaced apart from said interior and exterior sheets respectively by a damping material having a shore A hardness value in the range of from 0 to 60 according to ASTM D 2240-05(2010).

21. A method of manufacturing composite non-vision insulation panel unit in accordance with claim 1 comprising the steps of:
(i) wrapping/sheathing or framing one or more insulation panels with a damping material having a shore A hardness value in the range of from 0 to 60 according to ASTM D 2240-05(2010);
(ii) placing the product of step (i) on an exterior or interior sheet;
(iii) placing the other of said interior and exterior sheets onto the product of step (ii);
(iv) inserting a plurality of setting blocks between said interior and exterior sheets to define the distance there between; and
(v) filling all gaps between adjacent setting blocks with a sealant.

22. A method in accordance with claim 21 wherein subsequent to step (v), the setting blocks are removed.

23. A method in accordance with claim 22 wherein subsequent to removing the setting blocks, the gaps resulting from their removal are filled with additional sealant.
